(19) United States
(12) Patent Application Publication
(10) Pub. No.: US 2025/0209107 A1
(43) Pub. Date: Jun. 26, 2025

(54) DATA INTEGRATION, KNOWLEDGE EXTRACTION AND METHODS THEREOF

(71) Applicant: NExTNet Inc., Belmont, CA (US)

(72) Inventors: Pavan HOLUR, Belmont, CA (US); Arunava Steven BANERJEE, Belmont, CA (US); Derek PARK, Belmont, CA (US); Tyler MYERS, Belmont, CA (US); Emmanuel Oluwatope ALOFE, Belmont, CA (US)

(73) Assignee: NExTNet Inc., Belmont, CA (US)

(21) Appl. No.: 18/842,738

(22) PCT Filed: Apr. 21, 2023
(86) PCT No.: PCT/US2023/019491

§ 371 Date: Aug. 29, 2024

Related U.S. Application Data
(60) Provisional application No. 63/334,038, filed on Apr. 22, 2022.

(51) Int. Cl. G06F 16/358; G06F 40/211; G06F 40/289

(52) U.S. Cl. CPC G06F 16/358; G06F 40/211; G06F 40/289

(57) ABSTRACT

Disclosed herein are methods, systems, and modules for processing complex primary data and literature sources for easy, human-readable access.

### CROSS-REFERENCE TO RELATED APPLICATIONS

This application claims the benefit of priority to U.S. Provisional Patent Application Ser. No. 63/334,038, filed Apr. 22, 2022, hereby incorporated by reference in its entirety.

### FIELD

The embodiments disclosed herein are generally directed towards systems, software and methods for parsing and displaying scientific and biological data.

### BACKGROUND

There are many open-source bioinformatics tools to search and analyze data (See here for a list), yet, remain out-of-reach for the vast majority of scientists. Unfortunately, these tools are built piecemeal, created for the specific needs of a certain academic research group (e.g., Structure and Admixture), and they quickly become outdated due to lack of maintenance in keeping up the end-to-end technology infrastructure. Often, these tools are plagued with program bugs, lack extensibility to different subdomains and lack or have incomplete documentation.

For a biologist or a bench scientist who is required to query information and analyze biological and bioinformatics data, the currently utilized workflow involves the use of “flat-paged” search engines such as Google/PubMed and dated, rigid and limited-scope bioinformatic tools. Google/Bing search results only point to the location of documents and biological data sources, leaving scientists with the incredible task of having to spend many hours/weeks/months manually combing through these data silos, reading through individual documents and so on. Searching through these silos itself often takes domain expertise—a catch-22 situation; therefore the barrier to entry into this domain is high and there are two classes of bioinformaticians: those who are very qualified, often with advanced academic degrees who have gained the domain expertise through years of training, or those who have minimal to no knowledge in the biological space who may attempt to reference and learn from data silos that are orthogonal to a project's goal. This set of contributions attempts to address this gap. A majority of wet lab biologists and bench scientists in fact simply don't have the arsenal of computational tools that include SQL scripting, DB schemas, R libraries and scripts and Python packages (these sort of programming languages) or have limited knowledge to comb through such complex data.

There are limited proprietary tools available, but they mostly do text mining and largely ignore complex molecular data. In addition, most of the “black-box” AI systems of today for medicine, diagnostics and biomedical R&D make predictions for, say, some biological target, based on statistical confidence without any explanation or transparency as to why such predictions are made. This is one of the key reasons why very few AI and machine learning technologies or AI-designed drugs have made it to the clinic. These blackbox probabilistic models have opaque logic that are hard to explain and primarily designed by data scientists for other data scientists, bioinformaticians and computer scientists. Explainability or Interpretability is not factored into the design of modern AI models for hi-fidelity biomedical applications where a patient's life may be at stake depending on the chemical composition or biological characteristics of a drug. The conventional AI systems are not designed and developed for an average biologist or benchtop scientist with minimal or no data/computer science background.

Biological data is noisy and complex and requires bioinformatics skillset to transform, say, some non-human readable sequencing or raw gene expression microarray data into biological knowledge. Such sequencing data (in GBs to TBs) may contain 100s of millions of small codes of genetic information extracted from the cells that need to be quantified and transformed into a format comprehensible to a biologist.

Most biological data is also very confusing due to the non-uniform nomenclature of the terms. For example, genes and proteins have different aliases, synonyms and IDs from different data sources, different ontological associations, transcript differences (e.g., a single gene can have multiple transcripts or isoforms caused by alternative splicing of RNA leading to an increase in the complexity of both the transcriptome and proteome). This variation in nomenclature is often a result of history, as well, where different sub-disciplines of biomedical research have named genes and other biological entities in discipline-specific ways. Modern efforts to bring uniformity to these names do nothing to correct the large body of already-published studies that previously used different names. The challenge is that without a shared language or a common ontology, such heterogeneous and disjointed biological data don't cross-talk.

Moreover, there is an explosion of biomedical data of different modalities from scientific literature and electronic clinical data to molecular such as DNA/RNA sequencing, gene and protein expression, imaging data, sensor, and manufacturing data from drug development among others. Back in 2000, an average researcher had access to around 100 GB of molecular data. Today an average researcher has access to 10s of millions of PBs (1 PB is 1,000,000 GB). of molecular data, i.e., several orders of magnitude greater than in 2000. The availability of these data doesn't translate into their utility. When it comes to text level data, in excess of 10,000 biomedical papers that are published daily in the English language alone. A typical scientist can read through a maximum of 400 papers a year. With that rate, it would likely take more than two decades to read through all the information published just in the last 24 hours.

The ability to access, query and analyze all this heterogeneous data in a unified and user-friendly manner hasn't kept pace with this biomedical data explosion and has created a big analysis gap. Embodiments herein provide systems, methods, and software to minimize such gap. There is an ever-increasing need to organize integrate and contextualize scattered knowledge across these disparate and disjointed datasilos and clarify all that information to speed up biomedical research and the development of next-generation therapeutics.

In summary, the emergence of high resolution multi-modal data (e.g., in biotech, such data include sequencing, expression, imaging, video etc.) beyond just text has resulted in an enormous amount of human knowledge scattered across a multitude of data silos. The technical barrier to query and access the totality of the knowledge base has become remarkably complex, requiring deep expertise in coding, knowledge of querying languages and arcane statistics. Scientists spend a significant proportion of their valuable time searching through different databases or worrying about different data formats or arcane queries, instead of spending their time applying their intuition and domain expertise to discover new insights and following the scientific leads that they think are interesting. Billions of dollars are invested by organizations on biased decision making resulting from flawed or incomplete hypotheses of the domain experts.

### BRIEF SUMMARY

Embodiments herein leverage recent breakthroughs in natural language processing (NLP) and software and data management to build a digital infrastructure, which in certain embodiments is referred to as Sapiens, to supercharge knowledge discovery and decision making. Embodiments described herein organize and integrate the world's knowledge and make it accessible. In certain embodiments related to the natural language processing aspects, rapid advancements in training large-scale models efficiently and the abundance of text data on the internet, leads to the success of Large Language Models (LLMs) that use the Transformer architecture. These new models, in some embodiments, can model language statistics (word co-occurrences) better than the conventional approaches that previously employed RNN (Recurrent Neural Networks) or LSTM (Long Short Term Memory) models. Embodiments herein make it possible to solve tasks that are more “human” than what previous NLP models were capable of. Certain aspects can identify semantic relationships between concepts in the biomedical space. Certain aspects utilize database management systems and services, which have exponentially improved and can now match up to the power of networks and network-based AI/ML since it offers one way of creating an explainable infrastructure to generate insights or inferences. Recent advances on this front facilitated the construction of very large knowledge graphs that can be maintained and updated in milliseconds. Certain aspects utilize open-access datastores and public policy initiatives to make previously private data repositories public, which has leveled the playing field to construct large knowledge-scapes that have previously never been explored.

Disclosed are methods of querying, parsing, structuring, and/or visualizing data, where the method can comprise 1, 2, 3, 4, 5, 6, or more steps including any of the following: distilling each entry in a set of sources into one or more relationship tuples; separating each tuple from the distilling step into one or more semantic units and one or more links; connecting two semantic unit from step (b) with a link from step (b) if the conditional probability of the semantic unit and a link connection is greater than a threshold value, generating a schema of linked semantic unit; receiving an input from a user; and displaying a subset of the schema as a graphical user interface based on the input from the user.

In certain embodiments, the relationship tuples comprise a subject phrase, a verb phrase, and an object phrase where the subject and object phrases are from a set of phrases biological and bio-related entities. In some embodiments, the subject phrases and object phrases are semantic units and the verb phrases are links. In certain embodiments, the input received from the user is parsed to identify semantic units and/or links within the user input. In certain embodiments, fuzzy matching is used to compare the input received from the user to semantic units and/or links. In certain embodiments, the user input contains 1, 2, 3, 4, 5, 6, 7, 8, 9, 10, 11, 12, 13, 14, 15, or more semantic units and/or links. In certain embodiments, the user input may first be matched to primary sources (such as any database disclosed herein) then matched to secondary sources, such as research literature.

Certain methods further comprise developing a set of phrases by 1, 2, 3, 4, 5, 6, or more steps, including any of the following: creating a set of keywords and phrases as a seed set of queries; parsing, using a regular expression (Regex) parser, an entry creating a parsed set of phrases; comparing the parsed set to the seed set to find similarities between the parsed set and the seed set; adding the parsed set to the set of phrases when the parsed set and seed set are similar; adding phrases not included in the seed set that are identified in any one of steps (a)-(g) of claim 1 into the seed set. In some embodiments, the set of phrases comprises a set of curated phrases. The set of curated phrases may be curated by persons skilled in the art, who may be familiar with common phrases in the art. The set of phrases may comprise inputs received from any user, including previous users. The phrases within the set of phrases can be deprioritized. The phrases can be deprioritized by a decision process, such as by determining the frequency of the phrase in an input received from a user.

The set of sources may be developed by 1, 2, 3, 4, 5, 6, or more steps, including any of the following: defining a seed set of entries; creating a keywords and phrases set as a seed set of queries; parsing, using a regular expression parser, an entry creating a parsed set of phrases; comparing the parsed set to the seed set to find similarities between the parsed set and the seed set; and adding the entry to the seed set of entries when the parsed set and seed set are similar, generating the set of sources. The set of sources may be altered depending on the user. For example, the set of sources may be altered if the user does not have access to certain sources within the set of sources. The set of sources may comprise entries based on the access level of the user, including access level of certain databases, data sources, and/or literature's sources.

Certain methods also comprise cleaning at least one of the entries in the set of sources for phrase-level parsing. In some embodiments, the method further comprises transforming data sources found in the set of sources by 1, 2, 3, 4, 5, or more steps, including any of the following: identifying the structure of the data; identifying the source of the data; organizing one or more concepts of the data into one or more semantic units; and organizing a connection between at least two semantic units into a link.

Certain methods also comprise predicting new semantic units and links not present in the knowledge space by searching entries not in the set of sources. In some embodiments, the subject phrase, the verb phrase, and/or the object phrase comprise a phrase from the set of phrases. In some embodiments, the conditional probability of the semantic unit and a link connection is greater than a threshold value if the conditional probability of the semantic unit and a link connection is relatively more frequent than competing relationships and/or the link phrase has a high confidence. The high confidence may be determined by a context-sensitive model class, such as a transformer model. In some embodiments, the input from the user comprises an open-ended text segment.

Also disclosed herein are methods for identifying a set of sources relevant to a predetermined set of search queries. The methods can comprise 1, 2, 3, 4, 5, 6, or more steps, including any of the following: defining a seed set of entries; creating a keywords and phrases set as a seed set of queries; parsing, using a regular expression parser, an entry creating a parsed set of phrases; comparing the parsed set to the seed set to find similarities between the parsed set and the seed set; and adding the entry to the seed set of entries when the parsed set and seed set are similar, generating the set of sources.

Also described herein are systems, apparatuses, or other physical structures capable of performing any of the methods disclosed herein. In some embodiments, physical structure is a non-transitory computer-readable medium.

Also disclosed are modules configured to distill an entry in a set of documents sources into one or more relationship tuples. Wherein the relationship tuples may comprise a subject phrase, a verb phrase, and an object phrase where the subject and object phrases are from a set of phrases of biological and bio-related entities. Also disclosed are modules configured to separate each tuple into one or more semantic units and one or more links. The subject phrases and object phrases may be semantic units and the verb phrases may be links. Also disclosed are modules configured to connect two semantic units with a link if the conditional probability of the semantic unit and a link connection is greater than a threshold value, generating a schema of linked semantic units. Also disclosed are modules configured to receive an input from a user. Also disclosed are modules configured to display a subset of the schema as a graphical user interface based on the input from the user. In some embodiments, the modules disclosed herein are the present as the same module.

This specification describes various exemplary embodiments of systems, software and methods for analyzing, parsing, and displaying scientific research. The disclosure, however, is not limited to these exemplary embodiments and applications or to the manner in which the exemplary embodiments and applications operate or are described herein.

Unless otherwise defined, scientific and technical terms used in connection with the present teachings described herein shall have the meanings that are commonly understood by those of ordinary skill in the art. Further, unless otherwise required by context, singular terms shall include pluralities and plural terms shall include the singular.

It should be understood that while deep learning may be discussed in conjunction with various embodiments herein, the various embodiments herein are not limited to being associated only with deep learning tools. As such, machine learning and/or artificial intelligence tools generally may be applicable as well. Moreover, the terms deep learning, machine learning, and artificial intelligence may even be used interchangeably in generally describing the various embodiments of systems, software and methods herein.

Aspects of the disclosure include Aspects 1-7 provided below.

Aspect 1 is a method of querying, parsing, structuring and/or visualizing data, the method comprising the steps of:
(a) developing a seed set of phrases to initialize the process of knowledge acquisition;
(b) developing a search schema to efficiently query a set of documents comprising a majority number of seed phrases;
(c) distilling each document into one or more relationship tuples, wherein the relationship tuples comprise a subject phrase, a verb phrase, and an object phrase;
(d) separating each tuple from step (c) into one or more semantic units and one or more links, wherein the subject phrases and object phrases are semantic units and the verb phrases are links;
(e) connecting two semantic unit from step (d) with a link from step (d) if the conditional probability of the semantic unit and a link connection is relatively more frequent than competing relationships or the link phrase has a high confidence (as determined by a context-sensitive model class such as Transformers), generating a schema of linked semantic unit;
(f) receiving an input from a user as an open-ended text segment and/or comprising a phrase from the set of phrases; and
(g) displaying a subset of the larger span of acquired knowledge represented via a dynamic schema as a graphical user interface based on the input from the user.

Aspect 2 is the method of Aspect 1, wherein the developing a set of phrases comprises:
(a) creating a set of keywords and phrases as a seed set of queries;
(b) parsing, using a regular expression (Regex) parser, an entry creating a parsed set of phrases;
(c) comparing the parsed set to the seed set to find similarities between the parsed set and the seed set and extract the relevant documents using this similarity score;
(d) enabling feedback, wherein popular phrases not included in the seed set, but identified in the knowledge acquisition process from the extracted documents are inserted back into the seed set to expand the search space for new documents;

Aspect 3 is the method of Aspect 1 or 2, wherein developing a set of documents comprises:
(a) defining a seed set of entries;
(b) creating a set of keywords and phrases as a seed set of queries;
(c) parsing, using a regular expression parser, an entry creating a parsed set of phrases;
(d) comparing the parsed set to the seed set to find similarities between the parsed set and the seed set
(e) adding the entry to the seed set of entries when the parsed set and seed set are similar, generating the set of documents.

Aspect 4 is the method of any one of Aspects 1 to 3, further comprising cleaning all of the entries in the set of documents for phrase-level parsing.

Aspect 5 is the method of any one of Aspects 1 to 4, further comprising transforming data sources found in the set of documents comprising the steps of:
(a) identifying the structure of the data;
(b) identifying the layout of the data;
(c) organizing one or more concepts of the data into one or more semantic units; and
(d) organizing a connection between at least two semantic units into a link.

Aspect 6 is the method of any one of Aspects 1 to 5, further comprising predicting new semantic units and links not present in the knowledge space by searching entries not in the set of documents.

Aspect 7 is a method for identifying a set of documents relevant to a predetermined set of search queries, the method comprising the steps of:
(a) defining a seed set of entries;
(b) creating a keywords and phrases set as a seed set of queries;
(c) parsing, using a regular expression parser, an entry creating a parsed set of phrases;
(d) comparing the parsed set to the seed set to find similarities between the parsed set and the seed set; and
(e) adding the entry to the seed set of entries when the parsed set and seed set are similar, generating the set of documents.

### BRIEF DESCRIPTION OF THE DRAWINGS

FIG. 1 illustrates a block diagram illustrating a computer system 100, in accordance with various embodiments.

FIG. 2 illustrates an example representation of the fundamental units that constitute a knowledge graph 200, in accordance with various embodiments. The NEXTNet semantic units (NSUs) 204 and semantic links (NSLs) 206 are independent agents that work together to find the most likely joint structure to represent a larger connected concept. Data is aggregated from different heterogeneous silos 202. Semantic units are the smallest unit of knowledge represented by the tools described herein. Semantic units are connected through links where the potential connections of a pair of semantic units agree with one another.

FIG. 3 illustrates an example flow of processing steps that define the filtering rules for selecting documents, in accordance with various embodiments. The Bag-of-Phrases 300 contains specific phrases that are compared to each document in the larger corpus. The documents that have a high similarity to the core set and utilized for further processing and knowledge extraction as a set of select documents 302. The documents are also concurrently parsed to find important entities that are added to the existing bag of phrases in order to improve recall of important documents. Examples of phrases in the bag include “CD38”, “IL-21”, “upregulation”, and similar phrases, and examples of raw data sources include opensource documents, primary datasets, etc.

FIG. 4 illustrates an example of how select documents 402 (which may be the set of select documents 302) are parsed using the relationship extraction and entity recognition modules in order to extract and summarize the knowledge contained in the select documents at the conceptual level, in accordance with various embodiments. The NSU, including NSU 204, labels may be sub-phrases of the larger subject/object label. By using these labels as the potential connections in FIG. 2, the connectivity of the knowledge graph can be improved by creating more functional NSLs. An example of a context that after relationship extraction yields a subject→relationship→object tuple. This tuple is further processed to identify the NSU labels of the subject and object phrases. For example, a select source could recite “ . . . . Cd38 ligation differentially regulate the cell surface and intracellular expression of CDId protein . . . ” After relationship extraction and processing, “CD38” (from Cd38) is identified as the NSU subject, “ligation differential regulation” is identified as the NSL/relationship, and “expression of CD1d protein” is identified as the NSU object. This process can be repeated throughout the source to generate an set of relationships 406.

FIG. 5 illustrates how existing knowledge graphs also facilitate link prediction, wherein two NSUs are output by the model as being “potentially” connected, in accordance with various embodiments. Once the pair of NSUs 504, which may be NSU 204, is obtained, the pair is added to the core set of phrases in our bag, including Bag of Phrases 300, to search for documents that contain information about the pair of entities and the way in which they interact with one another. Extracting these new documents now facilitates realizing the link prediction by parameterizing the NSLs based on actual and discoverable data sources to establish a potential NSL 506, which may be an NSL 206. For example, as shown in the figure, link prediction may recommend the edge to connect the two NSU pairs, CD38 and Remnant-mediated axonal protection. Such process comprises a self-supervised feedback generation system. The generation system may then be used to populate the process of FIG. 3.

FIG. 6 illustrates an example of an object model, in accordance with various embodiments. a node represents a concept or an entity that is based on entity extraction from data sources including textual documents (scientific literature, patents etc.) 610 and non-textual (sequencing, expression atlases, imaging etc.) 612. The Properties 614 for textual documents include, among others, context (e.g. sentence or paragraph showcasing the raw text), a link to or ID of the source document, textual references to those bio-entities, or other document metadata. The Properties 614 for non-textual data include, among others, IDs, aliases and synonyms (say of genes and proteins), molecular function, or other biological properties. A bio-entity (a real-world representation of the non-human readable data such as sequencing, raw microarray expression atlas etc.) may have a bi-directional relationship with another bio-entity. These objects are connected to Properties 614, images, sequencing, i.e., they are data containers that hold the stored data. These in turn are tied to DBRs/DSRs (Database/source records) 604 which tie the data back to the data sources 602. The object can be related to another object via an object-to-object relationship (unidirectional or bi-directional: parent-child-parent) which also has DSRs that tie it back to data sources.

FIG. 7 illustrates an end-to-end no-code workflow, namely UTD AR, in accordance with various embodiments. Provided are non-exhaustive list of functionalities will allow users to upload their “behind the firewall” experimental data onto the platform securely, contextualize that data and understand how that is embedded in the broader knowledge space, and directly manipulate these relationships in their Enterprise Knowledge Graph, hence generate new hypothesis and actionable insights. Aspects that may be uploaded include data such as genomics, proteomics, metabolomics, documents, etc. Aspects that may transform include tagging and transforming internal data into Graph. Reports may be generated to share insights and decisions.

FIG. 8 illustrates an example of the graphical user interface, in accordance with various embodiments, which shows list functionality, metrics and top-down view of the ranked nodes.

FIGS. 9A-9B illustrate a feature that expands specific nodes based on user choice, in accordance with various embodiments. 9A illustrates a node for “Skin Hemangioma,” which is chosen for expansion and clicked on by the user. 9B illustrates an example of the results of a user selecting “Skin Hemangioma” where the subject has been added to the query terms top left box, and there are now additional nodes revealed on the graph which connect to the larger knowledge graph.

FIG. 10 illustrates an example of the platform automatically saving the state of the Graph, including Graph 200, keeping a visual navigation history of the user's act of search and analysis, in accordance with various embodiments. This allows the user to click on some earlier state of the Graph and go back in time.

FIG. 11 illustrates an example of the bi-directional flow tool (dots flowing in and out of the nodes) may be important when a user is performing deep searches around specific nodes, which adds new subgraphs, in accordance with various embodiments. This flow functionality helps the user track the movement of relationships in the network and keep a visual log/audit trail of how you zeroed in on certain key relationships.

FIG. 12 illustrates a tag directly in the Graph, including Graph 200, in accordance with various embodiments. Graph components can be directly tagged and saved by the user for future reference.

FIG. 13 illustrates an example of adding tags and defining relationship between content in unstructured text documents uploaded to the platform by users, in accordance with various embodiments

FIG. 14 illustrates an example of a hierarchical/tree view, in accordance with various embodiments. The graphical user interface may have different views: Auto: This is the default view. This automatically organizes the nodes and edges. Hierarchical/Tree: This organizes nodes into a hierarchical view. Grid: This organizes nodes into a grid. Circle: This organizes nodes into a circle. Minimal Crossing: This organizes with minimal crossing of lines. Linear sort: This enables sorting nodes into a straight line view.

FIG. 15 illustrates an example of the visualization of certain embodiments. Level 1: NLP algorithms allow automation of pipelines of heterogeneous data sources (from full-text scientific literature to complex and bio data such as sequencing and expression). Level 2: connecting these data semantically using graph algorithms and ontology, building an expanding “Knowledge Graph” of biological objects (cells, genes, proteins, disease). Level 3: in addition, a search and discovery engine surfaces a whole network of hidden relationships between the biological objects. Level 4: a suite of off-the-shelf no-code tools that will allow users to upload their internal data onto the platform, transform that into the Graph hence contextualizing their internal data and directly manipulate the Knowledge Graph, generating actionable insights that they can share across the Enterprise and making informed scientific and business decisions.

### DETAILED DESCRIPTION

### General Embodiments and Advantages

Certain embodiments concern advantages over existing technologies, including by one or more of:
Human-in-the-loop reinforcement learning to become smarter and faster with more data and human curated learning.
State-of-the-art natural language processing (NLP) that analyzes a vast corpus of multimedia data beyond text including molecular data such as DNA/RNA sequencing, gene and protein expression atlases, pharmacological information, imaging, audio, video among others extracting knowledge buried within these data sources and semantically linking into the rapidly knowledge graph with billions of contextualized relationships for users to query.
Explainable AI and Graphical User Interface (GUI) in which users can visualize, navigate, contextualize, and access primary evidence backing the connections in the Graph. This 3-dimensional nature of the interface makes it vastly superior than a 1-dimensional search engine.
Ease-of-use, which helps prevent a seminal problem of the high technical barrier to access scattered knowledge spread across multiple data silos 202. Embodiments utilize a fully no-code GUI where users can query in simple natural language.
Live collaboration and version control, similar to collaboration applications such as Google docs, embodiments herein have in-built suite of tools for users to jointly collaborate on hypothesis formation allowing users to share their scientific discovery/hypothesis with a link, giving live contextual feedback to their peers in real-time or see tagged content on the Graph that may have massive analytical value for the team among other functionalities.

Other tools apply NLP to text based data sources such as scientific publications, abstracts and conference papers. Embodiments herein can apply NLP to multimedia data including scientific text, images, molecular data (drug compounds, pathways, gene and protein expression, microbial and pathogen related data etc.), audio, video, etc. Unlike other flat front-end based search engines, certain embodiments' graphical user interface allows for visualization, navigation, manipulation, and editing of knowledge graphs. This can allow for the user to operate at the level of ideas and discover insights that really matter to them. In some embodiments, users can generate objective hypotheses based on totality of information instead of “best guesses” based on limited access to evidence via 1D search engines.

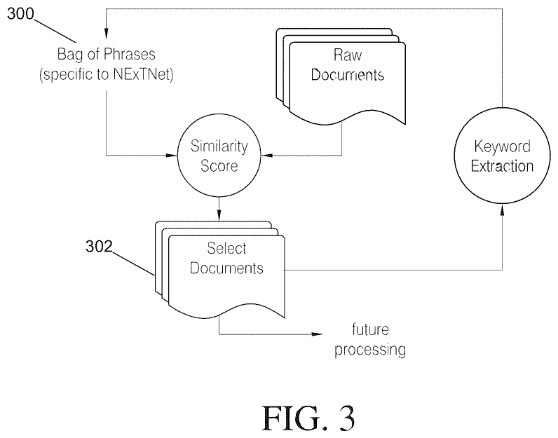

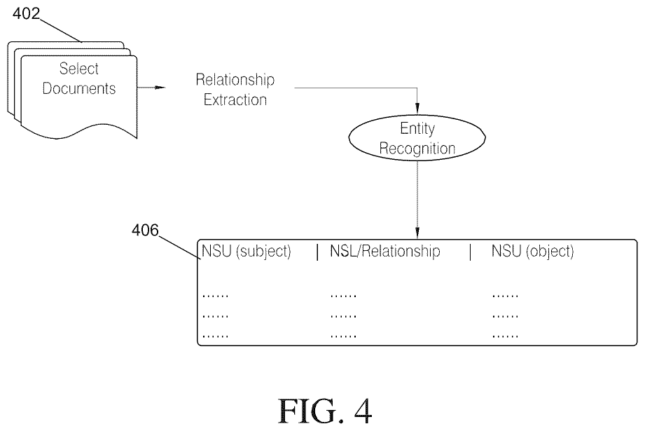

Certain embodiments concern a topic-specific literature extraction crawler. In certain embodiments, phrase and keyword matching, such as by regular expression (Regex) methods, extracts a subset of literature for indexing. An example of the literature extraction crawler is shown in FIG. 3. In certain embodiments, the Regex parser cleans the literature by removing superfluous information, such as headers, special characters, or irregular spacing. See for example, FIG. 4, which demonstrates an example of pulling relationship information from a source. The literature may be from the AWS corpus of open literature, PubMed, OSF, or other databases. Filtered documents may be serialized, including into an S3 data lake. In certain embodiments, phrase and keywords are aggregated in a semi-supervised way. In some embodiments, supervision is provided by a group of domain experts who identify a set number (such as ˜200 (or ‘x number of ’)) of key terms pertaining to an area of interest, a field, or a topic. The area of interest, field, or topic may be a particular disease, including one or more cancers, for example. This may comprise the first order searching technique. In some embodiments, the frameworks comprise at least one of BeautifulSoup, Selenium, NLTK, S3, and Athena.

In certain embodiments, the workflow for the literature extraction crawler comprises generating a seed set of keywords and phrases (for example: CD38, IL-21, upregulation, target identification, etc. in the biomedical space), which can be the Bag of Phrases 300. The seed set may be curated by domain experts in order to create a seed set of queries that find relevant work. In some embodiments, the seed set comprises a list of phrases annotated by hand. In some embodiments, the seed set comprises 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, or more (or any range derivable therein) phrases, which may be expert-curated and/or hand-annotated. In certain embodiments, the seed set comprises a large sample of phrases from open-source literature (such as from PubMed) and/or closed-source literature based on the input from the user. For each new literature segment, a regular expression (Regex) parser may find the similarity of the segment with respect to the seed set. In some embodiments, for a literature segment that is highly similar to the core set, the literature segment is cleaned and staged for phrase-level parsing. In turn, the approved documents, which may be the select documents 302, may be parsed to add to the core set of phrases so that the recall of future documents will improve. In some embodiments, user queries are stored. In some embodiments, frequent terms are used as input to populate the graph, set of documents, and/or seed set with more papers that contain these keywords. The stored user queries, which in some embodiments are included in the seed set, may be prioritize or deprioritized in the seed set. In some embodiments, the phrases are prioritized or deprioritized using a histogram of terms versus count. A threshold can be established for including or not including phrases into the seed set. In some embodiments, the threshold is established using the elbow method, which may prioritize finding paper that match highly frequent terms.

In certain embodiments, an extractor processes an entry (which may be a document, primary data source, secondary data source, etc.) in 1, 2, 3, 4, or more steps, which include any of the following: co-referencing phrases across the document to resolve pronouns, tokenizing the document into sentences, and passing the tokenized sentences into a language model (for example, SciBERT) to identify key scientific terms, which may become node labels. The tokenizing step may include, for each sentence, a returned list of relationship tubles, including as arg1, rel, arg2, where arg1 is the subject, rel is the verb phrase, and arg2 is the object. The passing step may include having the relationship (rel) tuples form the directed edge between nodes. In some embodiments, the synonyms and/or acronums are extracted for tuple args. Outputs for extractor processes may include synonyms for biological entities that match tuple args, as well as acronyms which may coincide with the args. For example, in some embodiments, the sentence “TNFRSF4 is a CD marker,” “TNFRSF4” would become a conceptual node for arg/with aliases such as OX40 extracted as conceptually synonymous. Additionally, “CD marker” is extracted as arg2 and the acronym CD marker is conceptual labeled “cluster of differentiation marker.” The association between the two sets of concepts (rel) is “is.” Information sources and confidence for these relationships are also extracted as support for the relationship.

In some embodiments, for each entry, at least one relationship is created, which can be the set of relationships 406. The relationships may interact in a network space, promoting nodes that are more popular and burying nodes that are not popular. Popularity can be determined by both collected user data and literature analyses. Popular nodes may be those which are found/expanded mostly by users, as well as those nodes whose composing literatures are highly cited. Lastly, popularity may also be increased by having a node which has a higher number of connections to other nodes in the graph.

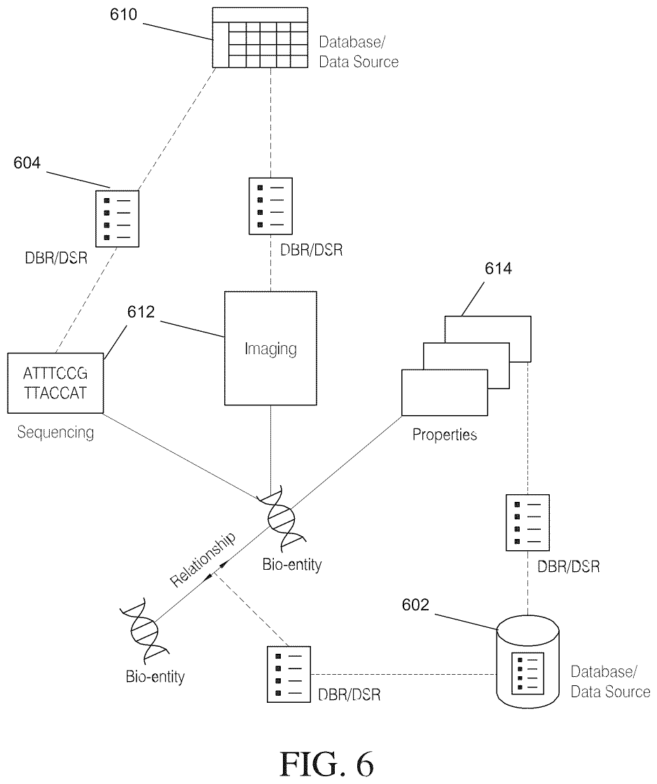

Certain embodiments concern semi-supervised custom schema generation and semantic unit generation for primary data sources. See for example, FIG. 6. In certain embodiments, primary data sources include HGNC, HPA, STRING, GO, UniProt, KEGG, MSigDB, TCGA, Disease Ontology, Reactome, Molecular Signature Database (GSEA-MSIGDB), Genome Browser, PathoPhenoDB, STRING-DB, AWS Open Source Data, NCBI, etc, which may be the open-source/open-access aspects of such databases. In some embodiments, primary data sources referred to frequently in literature (biomedical sources such as HGNC, HPA, STRING, GO, UniProt, KEGG, MSigDB, TCGA, Disease Ontology, Reactome, Molecular Signature Database (GSEA-MSIGDB), Genome Browser, PathoPhenoDB, STRING-DB, AWS Open Source Data, NCBI, etc.) are processed at scale on EC2 instances by transforming each sample into a semantic unit. The structure is introduced by a schema developed by the inventors. In some embodiments, each source has a different format. In some embodiments, the EC2 compute instances that process the corpora in one or more of the following manners: identify the structure of the data, identify the layout of different parts of the data, and organize each data sample into a semantic unit that has the potential to connect with other semantic units through a semantic link. In some embodiments, the schema is developed offline, including when sensitive information is handled. In some embodiments, semantic units recognize the core concept in a data sample. In some embodiments, semantic links are potential connections between semantic units based on the feature names and data types in the raw data.

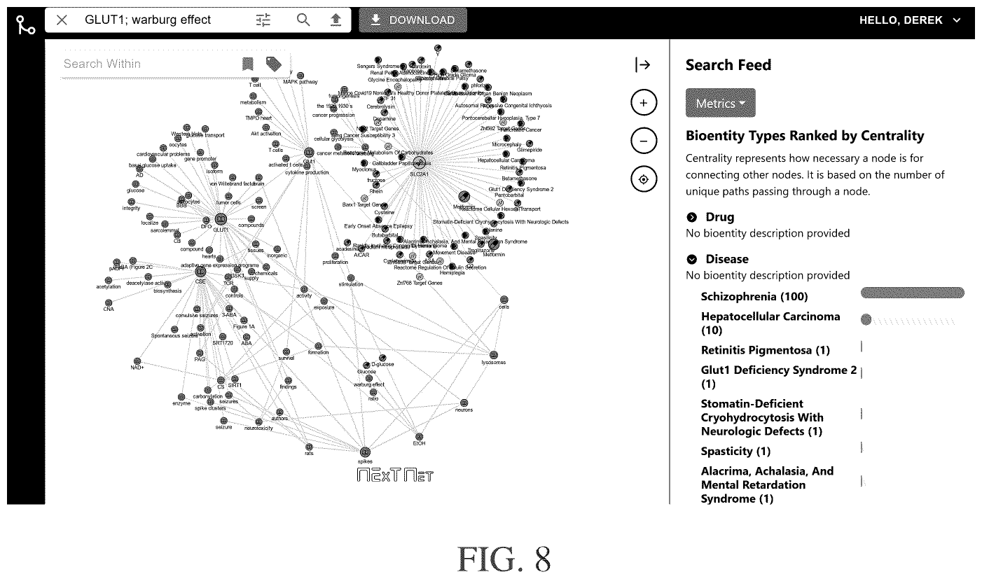

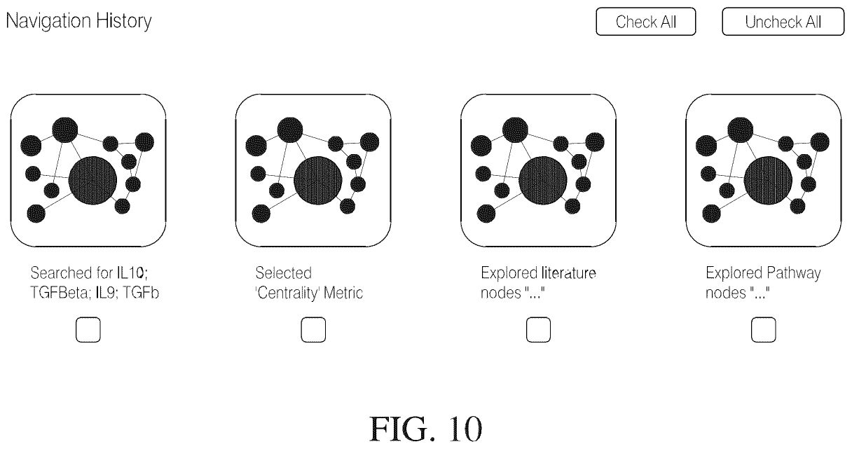

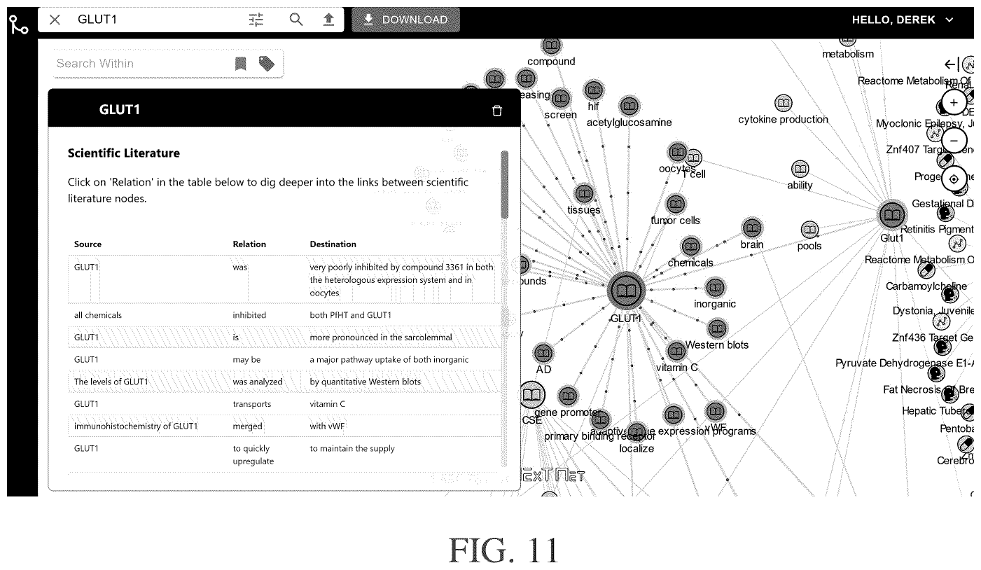

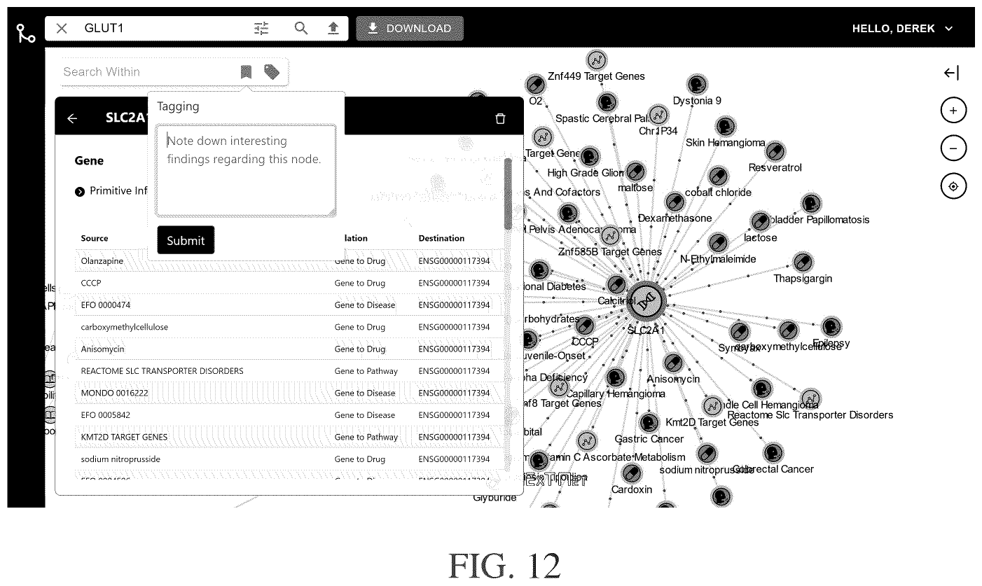

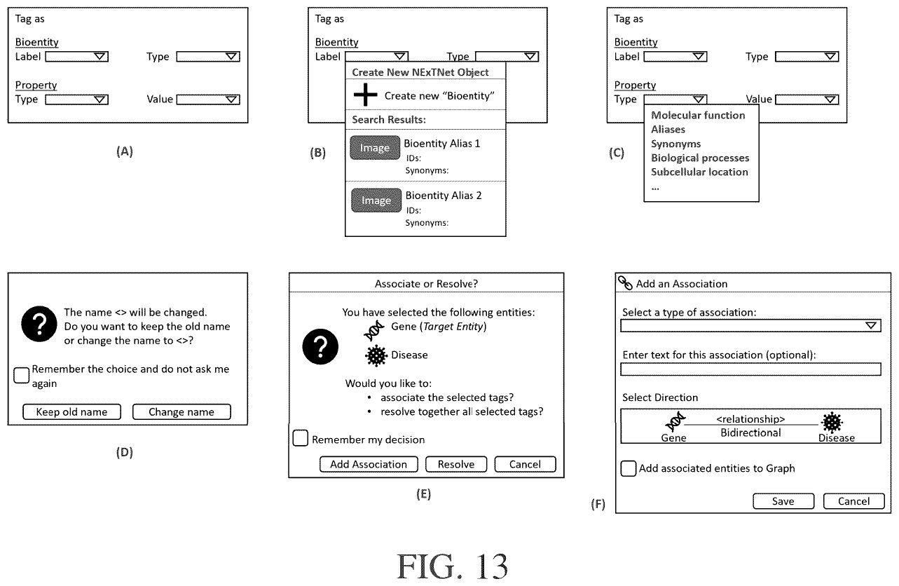

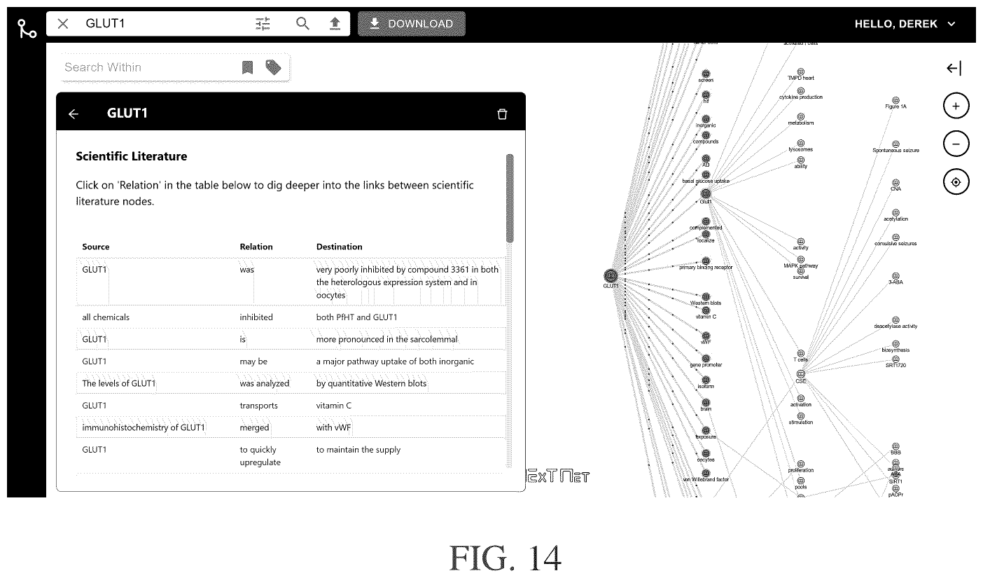

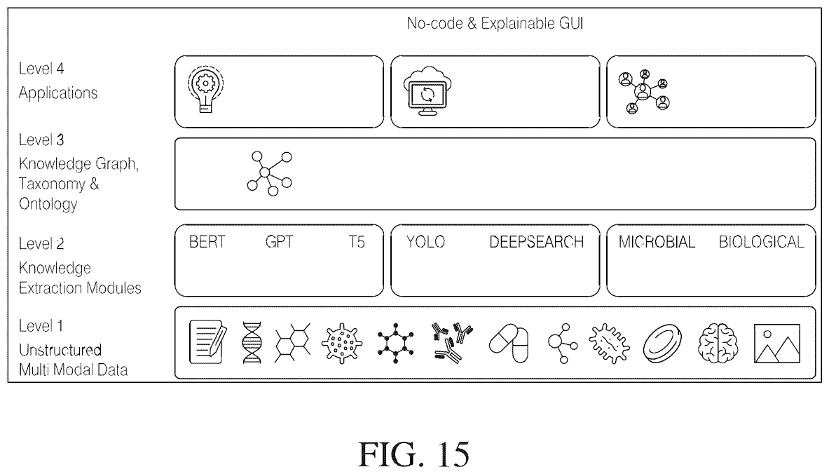

The subset of the schema may be determined by known biological relationships such as the central dogma of biology or other conventional representations used regularly in biomedical research, such as pathways. The schema may change with the evolution of research and as new databases of biological entities are created. Schemas can also be altered to accentuate specific relationships or concepts (edges or nodes). In certain embodiments, the user controls the information, such as which schema, are displayed. See for example FIGS. 8-15, which provide example display outputs based on user input. For example, the user can control the amount of information displayed with refining text queries, modifying degree of centrality, and/or filtering options. An example of this involves filtering nodes by their label (i.e. literature, gene, protein, etc.) to modify what type of information is displayed to the user. Another type of control is the degrees parameter within the platform. This measure may influence how many related nodes are surfaced per each of the user's queries. Deleting nodes from the displayed graph is also another method of filtering down the amount of information displayed. Refining the user's query with additional search terms can affect the amount of information displayed, in some embodiments.

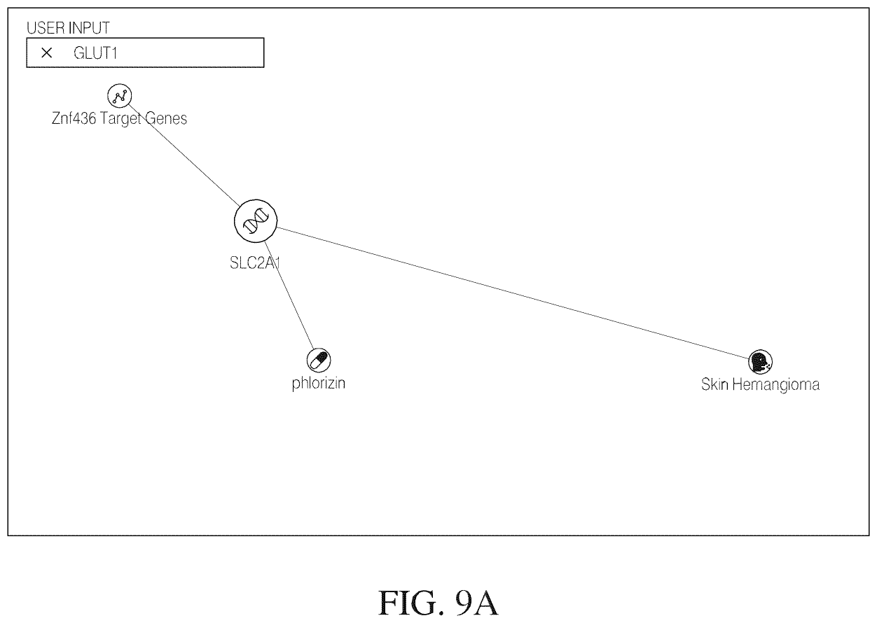

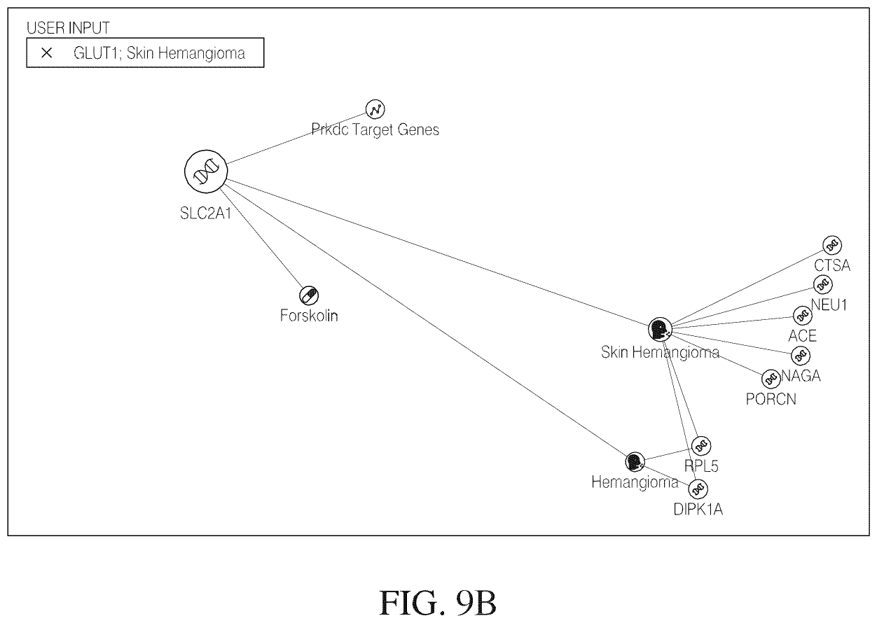

In certain embodiments, the nodes and edges are displayed as colors or animations, see for example FIG. 9, which shows different animations depending on the semantic unit type: drug, protein, gene, disease, etc. The color of the nodes and edges may allow the user to discern from different biological entities or literature, as well as visually indicate what type of relationship is being displayed. In some embodiments, each color node is a different label such as literature, gene, protein, pathway, disease, pathogen, or drug. Colored or animated edges between the nodes may indicate a different type of relationship such as gene to disease, disease to pathogen, or drug to disease, for example. Layers of complexity may be collapsed or expanded with ontologies and schemas. An example of this is providing expandable options in the schemas such as cellular location for proteins or spatial distribution of biological information within the human body, providing better resolution to the context of the problem. The described spatial, biological, ontological filtering, referred to as biological context in some aspects, may also be applied to different model organisms and cell types.

For example: a feature in UniProt called “ID” is more likely to be the ID of a semantic unit while the protein-protein co-occurrence in gene expression is a potential link, in some embodiments. More than one semantic unit can be created from a single data sample. If there are shared biological processes between proteins then the compute instance may identify that the shared process can be drawn out as a separate semantic unit. In some embodiments, the frameworks comprise at least one of LSDB, EC2, Pandas, and Spark. In some embodiments, the references for primary data sources comprise GeneOntology (http://geneontology.org), GenomeNet (https://www.genome.jp/kegg/), and/or KEGG.

Certain embodiments concern relationship extraction and semantic unit generation for secondary data sources. See for example, FIG. 4. In some embodiments, raw document text from one or more literature sources (e.g. an article) is distilled into relationship tuples (subject phrase, verb phrase, object phrase). Each part of the tuple may be extracted as a span of text from the document. The schema to create a semantic unit with such a relationship may be as follows: the object is one semantic unit and the subject is another semantic unit. The link from the subject to the object is a semantic link. In some embodiments, the same concept can be represented by multiple spans.

In some embodiments, relationships are extracted with a modified and parallelized extractor, which may be the extractor found at https://github.com/dair-iitd/OpenIE-standalone. In some embodiments, a many-to-one map from multiple subjects and objects to the same concept span may be designed by using a bio-medical entity span database. For example, “the rare CD38” or “CD38” map to the same concept “CD38”. The variations of each relationship may then be relegated to the semantic link. For example, the relationship tuple “the CD38 molecule, targets, the lymphoma” can be represented as:

SEMANTIC UNIT: {CD38}, {Lymphoma}

SEMANTIC LINK: {subject phrase: the CD38 molecule, relationship: targets, object phrase: the lymphoma}

The semantic link can have its own features, including how exactly two semantic units be connected. A span model can be found at https://github.com/allenai/scispacy.

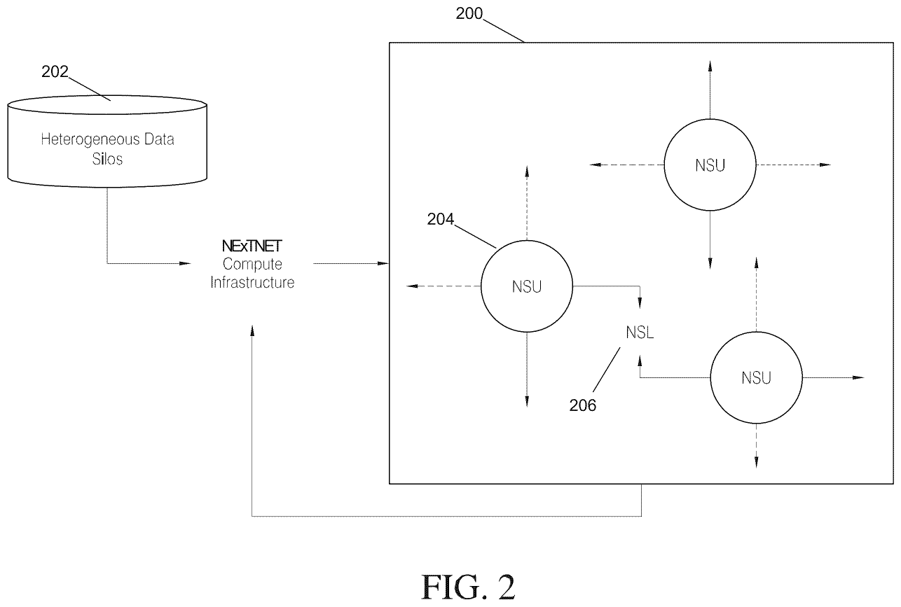

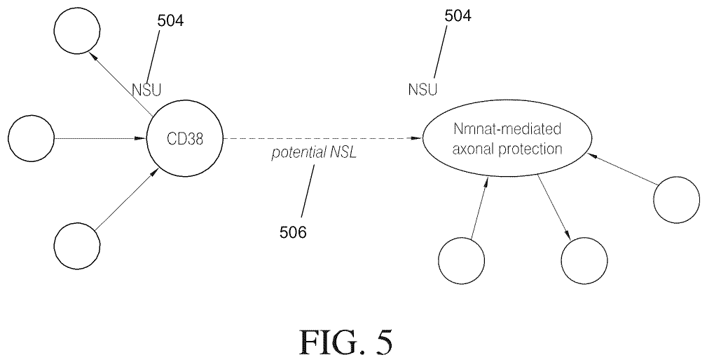

Certain embodiments concern self-organizing millions of semantic units, including NSUs 204 through semantic link edges, including NSLs 206, as shown in FIG. 2. In some embodiments, a key insight is that the semantic units modeled from primary (non-textual) and secondary (textual) data as relationship tuples can be jointly represented as a network of semantically linked concepts. The edges of this network are semantic links that create a “living” self-organizing network, and each semantic link connects a pair of semantic units based on a likelihood estimate: if P (semantic unit_target|semantic unit_source, semantic link_type)>threshold, then the semantic link connects the pair of semantic units. In certain state-of-the-art link prediction tasks, a Deep Learning (DL) model is tasked with producing a score between 0 and 1 at the classification layer, the output of a softmax or similar non-linearity applied on the logits. The threshold may be manually set to a high value (0.90) so that only relationships that are most likely are displayed to the end user. See for example FIG. 5, which shows an example of a predicted link between two units. In some embodiments, a graph component comprising two nodes (semantic units) and between them one edge (semantic link) is produced. In some embodiments, this solves a technical problem in the field because the resulting graph can be assembled iteratively. For example, new semantic units and semantic links can be incrementally added to the network continually improving the connections between concepts. In some embodiments, each node is a concept, lending classical page-ranking algorithms new-found resolution in a concept-ranking framework instead. For example, methods herein can add relevance in the form of ranking algorithms on pages, videos, publications and other media to address user interest with a proxy to concepts by looking at higher-level features such as entire documents.

In certain embodiments, aspects of a certain source are displayed or not displayed based on a decision process. The decision process may be based on the node degree, such as the number of relationships featuring the node. In certain embodiments, the decision process is based on centrality scores, such as betweenness and/or degree scores. These scores may include one or more of the following: (a) Betweenness Centrality: a metric that evaluates how frequently a node is traversed in a random walk; (b) Degree Centrality: a metric that evaluates the “attractive” influence of the node in the graph—the sum of the outgoing and incoming connections; (c) Suitability: Large Language Models (LLMs) when prompted with a query such as: “Is this node {node} important given the context: {context}?” can inform about the “importance” or the relevance of the node given the input context. In other cases, the suitability metric may be applied in static settings, wherein nodes and edges are tagged on a 5-step scale for their overall usefulness.

Recent platforms are now making it possible to scale such a massive network: Infinite vocabulary networks comprising billions of semantic units and semantic links can be queried in a matter of milliseconds thanks to recent advances in DBMS (Database management systems), most notably AWS Neptune.

Certain embodiments concern serverless architecture. In some embodiments, economically parsing and mutating the graph structure is affordable due to recent serverless architecture advances including AWS Lambda setups. See: https://aws.amazon.com/neptune/, https://aws.amazon.com/lambda/.

In some embodiments, semantic units and semantic links are self-organized. In some embodiments, each semantic unit has a set of potential semantic links that allow them to interact with each other in an automated way. For example, a semantic link may be successful in connecting a pair of semantic units if P (semantic unit_target|semantic unit_source, semantic link_type)>threshold. Examples of the threshold include standard thresholds for statistical significance, Bayesian statistics, scoring metrics based on a trained language model or arbitrarily determined for a desired graph connectivity. Each semantic unit this way is given its own “agency”, it may traverse the existing knowledge space and decide the points at which to integrate into the space. In some embodiments, wherein each semantic unit functions independent of the other, it enables distributed computing. For example, each semantic unit is allocated a separate compute resource that monitors whether the semantic unit can make or break connections to others. Such a distributed and highly variable-in-size computing environment may be made possible today by a serverless system, such as AWS Lambda.

Certain embodiments concern graph-traversal algorithms and searches. In some embodiments, the resulting graph of semantic units connected by semantic links requires creating custom search functions. The search functions may be developed on Gremlin and Neo4J and Search Engine Optimization (SEO) to provide for fast and accurate search experience. In some embodiments, for a search query: the query Q is decomposed via advanced Language Model (LM) parsing algorithms and the key search phrases are identified, for example as “P”. The phrases P may then be sieved into different graph components that they are most likely to represent: for example, since semantic units most likely reflect concepts, noun phrases from the search query are compared exclusively to semantic units. Specific queries are reserved for semantic links and co-occurring metadata as well. In some embodiments, once the phrases are classified, they are matched to the existing network using a fast Full-Text Search on the semantic unit and semantic link properties. The returned graph units may then be processed to return the connected component that connects all units. Each search option (such as visualization effects, aggressiveness in finding the connected component, the prioritization of graph units) may require facilitating backend support to optimize the search functionality's speed to support these means.

Certain embodiments concern self-iterating (i.e. self-correcting) network augmentation. In certain embodiments, where a knowledge graph connects semantic units via semantic links, such a graph provides the infrastructure to successfully apply Link Prediction, a typical ML algorithm, that attempts to create new links. Link Prediction may be used for finding or improving gaps in current scientific understanding, e.g. in biology, including aspects such as drug repurposing, improving microbial therapies, and/or targeting holes in the biotech landscape for further exploration. In addition to link prediction, some embodiments reverse engineer the missing data that is required to support a new link. For example, for each pair of nodes predicted to connect to one another via a link, query the node labels in an extended literature corpus and identify and parse text segments in which these concepts co-occur. In this way, the network is supported by an auto-extracted set of critical datasets, which is semi-supervised. While the first set of literature is found via a set of core keywords, the graph self-augments by searching for text segments online that contain the pair of nodes that are most likely to be related (in order to find the right semantic link).

Certain embodiments concern data sources including collections of references to data. In some embodiments, data objects, such as in a schema, are a way to track pieces of data back to the data source that they came from but they don't contain any data themselves. In some embodiments, data objects do contain data, including the source of the text document or image or video or other non-textual data or whatever they are storing. In some embodiments, a primary object property is attached to a data source and this allows us to tie the data source to the data object that contains its data. This may be used with data sources that represent unstructured data such as scientific literature, word docs, emails, handwritten notes, etc.

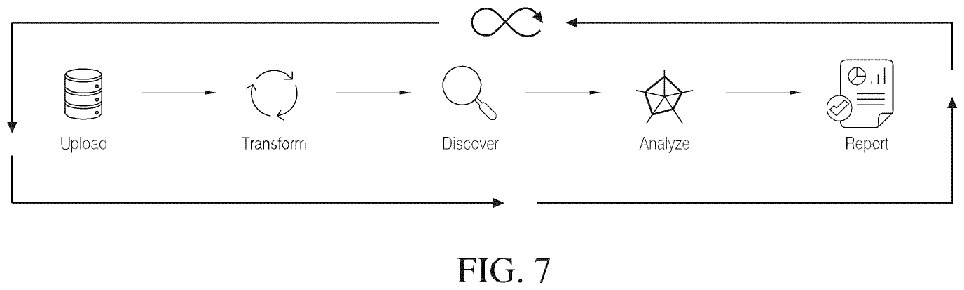

Certain embodiments allow a user to upload data into a database, platform, system, or schema disclosed herein. See for example, FIG. 7, which shows a workflow of user input data to end reporting. Certain embodiments allow for unsupervised, semi-supervised, and/or supervised learning to infer new units or links (semantic or otherwise) via typical ML models, graph topology, and/or graph embeddings. Certain embodiments use characteristic data from existing units to predict perturbations that augment the likelihood of a new unit connecting to links within the network. In certain embodiments, the modification to molecular data (Protein, Drug, etc.) can design more effective therapeutic treatments. Certain embodiments generate links between network units by comparing representative data. For example, some embodiments predict candidate existing drugs which can be repurposed for known diseases.

### Computer Implemented System

In various embodiments, the systems and methods for analyzing, parsing, and displaying scientific research can be implemented via computer software or hardware.

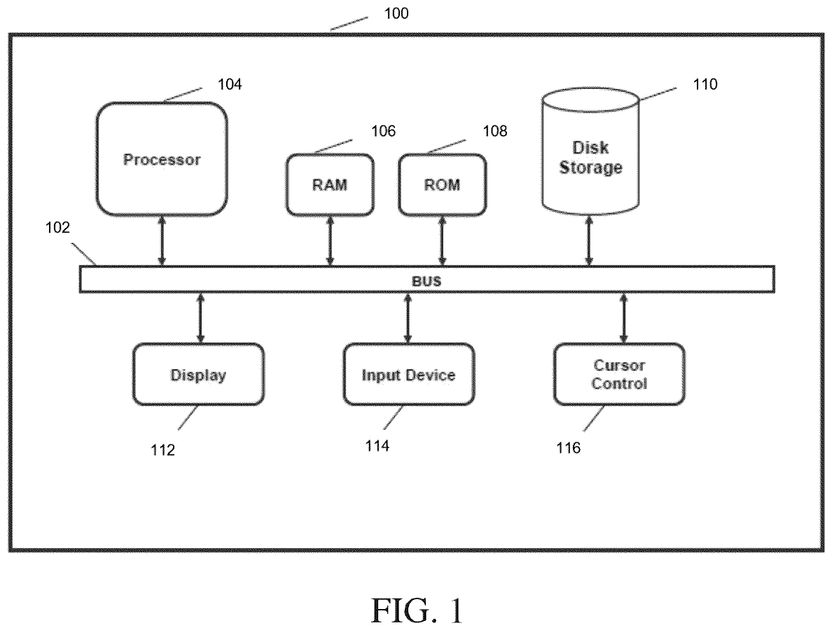

FIG. 1 is a block diagram illustrating a computer system 100 upon which embodiments of the present teachings may be implemented. In various embodiments of the present teachings, computer system 100 can include a bus 102 or other communication mechanism for communicating information and a processor 104 coupled with bus 102 for processing information. In various embodiments, computer system 100 can also include a memory, which can be a random-access memory (RAM) 106 or other dynamic storage device, coupled to bus 102 for determining instructions to be executed by processor 104. Memory can also be used for storing temporary variables or other intermediate information during execution of instructions to be executed by processor 104. In various embodiments, computer system 100 can further include a read only memory (ROM) 108 or other static storage device coupled to bus 102 for storing static information and instructions for processor 104. A storage device 110, such as a magnetic disk or optical disk, can be provided and coupled to bus 102 for storing information and instructions.

In various embodiments, computer system 100 can be coupled via bus 102 to a display 112, such as a cathode ray tube (CRT) or liquid crystal display (LCD), for displaying information to a computer user. An input device 114, including alphanumeric and other keys, can be coupled to bus 102 for communication of information and command selections to processor 104. Another type of user input device is a cursor control 116, such as a mouse, a trackball or cursor direction keys for communicating direction information and command selections to processor 104 and for controlling cursor movement on display 112. This input device 114 typically has two degrees of freedom in two axes, a first axis (i.e., x) and a second axis (i.e., y), that allows the device to specify positions in a plane. However, it should be understood that input devices 114 allowing for 3-dimensional (x, y and z) cursor movement are also contemplated herein.

Consistent with certain implementations of the present teachings, results can be provided by computer system 100 in response to processor 104 executing one or more sequences of one or more instructions contained in memory 106. Such instructions can be read into memory 106 from another computer-readable medium or computer-readable storage medium, such as storage device 110. Execution of the sequences of instructions contained in memory 106 can cause processor 104 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, etc.) or “computer-readable storage medium” as used herein refers to any media that participates in providing instructions to processor 104 for execution. Such a medium can take many forms, including but not limited to, non-volatile media, volatile media, and transmission media. Examples of non-volatile media can include, but are not limited to, dynamic memory, such as memory 106. Examples of transmission media can include, but are not limited to, coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, another memory chip or cartridge, or any other tangible medium from which a computer can read.

In addition to computer-readable media, instructions or data can be provided as signals on transmission media included in a communications apparatus or system to provide sequences of one or more instructions to processor 104 of computer system 100 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, etc.

It should be appreciated that the methodologies described herein, flow charts, diagrams and accompanying disclosure can be implemented using computer system 100 as a standalone device or on a distributed network or shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 100, whereby processor 104 would execute the analyses and determinations provided by these engines, subject to instructions provided by any one of, or a combination of, memory components 106/108/110 and user input provided via input device 114.

In describing the various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments. Similarly, any of the various system embodiments may have been presented as a group of particular components. However, these systems should not be limited to the particular set of components, now their specific configuration, communication and physical orientation with respect to each other. One skilled in the art should readily appreciate that these components can have various configurations and physical orientations (e.g., wholly separate components, units and subunits of groups of components, different communication regimes between components).

Although specific embodiments and applications of the disclosure have been described in this specification, these embodiments and applications are exemplary only, and many variations are possible.

What is claimed is:

1. A method of querying, parsing, structuring, and/or visualizing data, the method comprising the steps of:
(a) distilling each entry in a set of sources into one or more relationship tuples, wherein the relationship tuples comprise a subject phrase, a verb phrase, and an object phrase where the subject and object phrases are from a set of phrases biological and bio-related entities;
(b) separating each tuple from step (a) into one or more semantic units and one or more links, wherein the subject phrases and object phrases are semantic units and the verb phrases are links;
(c) connecting two semantic unit from step (b) with a link from step (b) if the conditional probability of the semantic unit and a link connection is greater than a threshold value, generating a schema of linked semantic unit;
(d) receiving an input from a user; and
(e) displaying a subset of the schema as a graphical user interface based on the input from the user.

2. The method of claim 1, wherein the method further comprises developing a set of phrases by:
(a) creating a set of keywords and phrases as a seed set of queries;
(b) parsing, using a regular expression (Regex) parser, an entry creating a parsed set of phrases;
(c) comparing the parsed set to the seed set to find similarities between the parsed set and the seed set; and
(d) adding the parsed set to the set of phrases when the parsed set and seed set are similar.

3. The method of claim 2, further comprising
(e) adding phrases not included in the seed set that are identified in any one of steps (a)-(d) of claim 1 into the seed set.

4. The method of claim 1, wherein the set of phrases comprises a combination of curated phrases and queries input by at least one previous user.

5. The method of claim 4, wherein one or more phrases in the set of phrases are deprioritized within the set based on input from at least one previous user.

6. The method of any one of claims 1 to 5, wherein the set of sources is developed by a method comprising:
(a) defining a seed set of entries;
(b) creating a keywords and phrases set as a seed set of queries;
(c) parsing, using a regular expression parser, an entry creating a parsed set of phrases;
(d) comparing the parsed set to the seed set to find similarities between the parsed set and the seed set; and
(e) adding the entry to the seed set of entries when the parsed set and seed set are similar, generating the set of sources.

7. The method of any one of claims 1 to 6, wherein the set of sources comprises entries based on the access level of the user.

8. The method of any one of claims 1 to 7, further comprising cleaning at least one of the entries in the set of sources for phrase-level parsing.

9. The method of any one of claims 1 to 8, further comprising transforming data sources found in the set of sources comprising the steps of:
(a) identifying the structure of the data;
(b) identifying the layout of the data;
(c) organizing one or more concepts of the data into one or more semantic units; and
(d) organizing a connection between at least two semantic units into a link.

10. The method of any one of claims 1 to 9, further comprising predicting new semantic units and links not present in the knowledge space by searching entries not in the set of sources.

11. The method of any one of claims 1 to 10, wherein the subject phrase, the verb phrase, and/or the object phrase comprise a phrase from the set of phrases.

12. The method of any one of claims 1 to 11, wherein the conditional probability of the semantic unit and a link connection is greater than a threshold value if the conditional probability of the semantic unit and a link connection is relatively more frequent than competing relationships and/or the link phrase has a high confidence.

13. The method of claim 12, wherein high confidence is determined by a context-sensitive model class.

14. The method of claim 13, wherein the context-sensitive model class is a transformer model.

15. The method of any one of claims 1 to 14, wherein the input from the user comprises an open-ended text segment.

16. A method for identifying a set of sources relevant to a predetermined set of search queries, the method comprising the steps of:
(a) defining a seed set of entries;
(b) creating a keywords and phrases set as a seed set of queries;
(c) parsing, using a regular expression parser, an entry creating a parsed set of phrases;
(d) comparing the parsed set to the seed set to find similarities between the parsed set and the seed set; and
(e) adding the entry to the seed set of entries when the parsed set and seed set are similar, generating the set of sources.

17. A non-transitory computer-readable medium configured to perform the method of any one of claims 1-16.

18. A module configured to distill an entry in a set of documents sources into one or more relationship tuples, wherein the relationship tuples comprise a subject phrase, a verb phrase, and an object phrase where the subject and object phrases are from a set of phrases biological and bio-related entities; separate each tuple from step (a) into one or more semantic units and one or more links, wherein the subject phrases and object phrases are semantic units and the verb phrases are links; connect two semantic unit from step (b) with a link from step (b) if the conditional probability of the semantic unit and a link connection is greater than a threshold value, generating a schema of linked semantic unit; receive an input from a user; and display a subset of the schema as a graphical user interface based on the input from the user.
